(19) United States
(12) Patent Application Publication
(10) Pub. No.: US 2025/0237823 A1
(43) Pub. Date: Jul. 24, 2025

(54) ALIGN KEY INCLUDING META-LENS AND META-MIRROR, AND ALIGNING APPARATUS INCLUDING ALIGN KEY

(71) Applicants: SAMSUNGELECTRONICSCO.,LTD., Suwon-si (KR); UNIVERSITY OF MASSACHUSETTS, Boston, MA (US)

(72) Inventors: Seunghoon HAN, Suwon-si (KR); Maryam GHAHREMANI, Amherst, MA (US); Amir ARBABI, Amherst, MA (US); Kyuhwan CHOI, Suwon-si (KR); Heejin CHOI, Suwon-si (KR)

(73) Assignees: SAMSUNGELECTRONICSCO.,LTD., Suwon-si (KR); UNIVERSITY OF MASSACHUSETTS, Boston, MA (US)

(21) Appl. No.: 19/029,364

(22) Filed: Jan. 17, 2025

Related U.S. Application Data
(60) Provisional application No. 63/623,002, filed on Jan. 19, 2024.

(30) Foreign Application Priority Data
Oct. 17, 2024 (KR) 10-2024-0142302

(51) Int. Cl. G02B 6/42; G02B 1/00

(52) U.S. Cl. CPC G02B 6/4224; G02B 1/002

(57) ABSTRACT

An align key includes a meta-lens including a first meta-lens and a second meta-lens, which are provided with a plurality of first nanostructures, and a meta-mirror provided to face the meta-lens while being spaced apart from the meta-lens and including a first meta-mirror and a second meta-mirror, which are provided with a plurality of second nanostructures. Based on a configuration of the plurality of first nanostructures, the first meta-lens and the second meta-lens have focal lengths of opposite signs, and based on a configuration of the plurality of second nanostructures, the first meta-mirror and the second meta-mirror have focal lengths of opposite signs. An interference pattern is formed based on the first meta-lens and the first meta-mirror configured to transmit and reflect a first light beam of incident light, and the second meta-lens and the second meta-mirror configured to transmit and reflect a second light beam of the incident light.

### CROSS-REFERENCE TO RELATED APPLICATIONS

This application is based on and claims priority under 35 U.S.C. § 119 to U.S. Provisional Application No. 63/623,002, filed on Jan. 19, 2024, and Korean Patent Application No. 10-2024-0142302, filed on Oct. 17, 2024, in the Korean Intellectual Property Office, the disclosures of which are incorporated by reference herein in their entireties.

### BACKGROUND

### 1. Field

The disclosure relates to an align key including a meta-lens and a meta-mirror, and an aligning apparatus including the align key.

### 2. Description of the Related Art

The degree of integration of various integrated circuit devices including, but not limited to, a memory, a driving integrated circuit (IC), a logic device, an image sensor, etc., is gradually increasing. Accordingly, the sizes of electronic devices provided in the integrated circuit devices are also decreasing. In addition, optical devices are also made flat in a nanostructure on a wafer substrate.

These electronic devices and optical devices formed on different substrates may be integrated into a single package by utilizing an align mark provided on each substrate. The align marks may include patterns that transmit and reflect light, and the degree of alignment may be confirmed by detecting transmission, reflection, and scattering patterns according to an overlay form of the align marks facing each other.

In order to improve alignment accuracy and precision, the shape dimension of patterns included in the align mark may be reduced. However, it is difficult to implement measurement accuracy and precision of a sub-micron, for example, 100 nm level, due to an optical resolution limit.

### SUMMARY

Provided are an align key capable of increasing alignment accuracy and precision when manufacturing an electronic device and an aligning apparatus including the same.

Additional aspects will be set forth in part in the description which follows and, in part, will be apparent from the description, or may be learned by practice of the presented embodiments of the disclosure.

According to an aspect of the disclosure, there is provided an align key including: a meta-lens including a first meta-lens and a second meta-lens, each of the first meta-lens and the second meta-lens provided with a plurality of first nanostructures; and a meta-mirror provided to face the meta-lens while being spaced apart from the meta-lens, the meta-mirror including a first meta-mirror and a second meta-mirror, each of the first meta-mirror and the second meta-mirror provided with a plurality of second nanostructures, wherein, based on a configuration of the plurality of first nanostructures, the first meta-lens and the second meta-lens have focal lengths of opposite signs, wherein, based on a configuration of the plurality of second nanostructures, the first meta-mirror and the second meta-mirror have focal lengths of opposite signs, wherein an interference pattern is formed based on the first meta-lens and the first meta-mirror configured to transmit and reflect a first light beam of incident light, and the second meta-lens and the second meta-mirror configured to transmit and reflect a second light beam of the incident light.

The first meta-lens may have a positive focal length based on the plurality of first nanostructures provided in the first meta-lens, the second meta-lens may have a negative focal length based on the plurality of first nanostructures provided in the second meta-lens, the first meta-mirror may have a negative focal length based on the plurality of second nanostructures provided in the first meta-mirror, and the second meta-mirror may have a positive focal length based on the plurality of second nanostructures provided in the second meta-mirror.

The first meta-lens and the first meta-mirror may be configured such that the first light beam is reflected by the first meta-mirror, and the first light beam that has been reflected by the first meta-mirror is transmitted through the first meta-lens, and the second meta-lens and the second meta-mirror may be configured such that the second light beam is reflected by the second meta-mirror, and the second light beam that has been reflected by the second meta-mirror is transmitted through the second meta-lens.

The first meta-lens and the first meta-mirror may be configured such that the first light beam is transmitted through the first meta-lens, and the first light beam that has been transmitted through the first meta-lens is reflected by the first meta-mirror, and the second meta-lens and the second meta-mirror may be configured such that the second light beam is transmitted through the second meta-lens, and the second light beam that has been transmitted through the second meta-lens is reflected by the second meta-mirror.

The plurality of first nanostructures or the plurality of second nanostructures may have a cylindrical or polygonal pillar shape.

The plurality of first nanostructures or the plurality of second nanostructures may include a first-layer nanostructure and a second-layer nanostructure arranged on the first-layer nanostructure.

The second-layer nanostructure may have an asymmetric cross-section in which a major axis and a minor axis are defined, and an arrangement angle of the major axis may be arranged differently according to a position of the second-layer nanostructure.

Based on a shape distribution of the plurality of first nanostructures, at least one of the first meta-lens and the second meta-lens may be further configured to deflect the incident light and emit the deflected incident light.

The first meta-lens may be an annular region with an outer radius r1 and an inner radius r2; and the second meta-lens may be an annular region with an outer radius r3 and an inner radius r4. The first meta-mirror may be an annular region with an outer radius r5 and an inner radius r6; and the second meta-mirror may be an annular region with an outer radius r7 and an inner radius r8, wherein r1>r2>r5>r6>r7>r8>r3>r4.

The first meta-lens may include a first first meta-lens and a second first meta-lens, the second meta-lens may include a first second meta-lens and a second second meta-lens, the first first meta-lens, the first second meta-lens, the second second meta-lens, and the second first meta-lens are sequentially spaced apart from each other, the first meta-mirror may include a first first meta-mirror and a second first meta-mirror, the second meta-mirror may include a first second meta-mirror and a second second meta-mirror, the first first meta-mirror, the first second meta-mirror, the second second meta-mirror, and the second first meta-mirror are sequentially spaced apart from each other, and each of the first first meta-lens, the first second meta-lens, the second second meta-lens, and the second first meta-lens has a rectangular shape.

According to another aspect of the disclosure, there is provided an aligning apparatus including: a light source configured to a first light beam and a second light beam; a first structure provided with a meta-lens including a first meta-lens and a second meta-lens, each of the first meta-lens and the second meta-lens provided with a plurality of first nanostructures; a second structure provided to face the first structure while being spaced apart from the first structure, the second structure provided with a meta-mirror including a first meta-mirror and a second meta-mirror, each of the first meta-mirror and the second meta-mirror provided with a plurality of second nanostructures; an imaging device configured to measure an interference pattern formed by the first light beam transmitted and reflected by the first meta-lens and the first meta-mirror and the second light beam transmitted and reflected by the second meta-lens and the second meta-mirror; a processor configured to analyze an alignment state between the first structure and the second structure based on the interference pattern; and a driving unit configured to move one of the first structure and the second structure according to control by the processor to change a relative positional relationship between the first structure and the second structure, wherein, based on a configuration of the plurality of first nanostructures, the first meta-lens and the second meta-lens have focal lengths of opposite signs, wherein, based on a configuration of the plurality of second nanostructures, the first meta-mirror and the second meta-mirror have focal lengths of opposite signs.

The first meta-lens may have a positive focal length based on the plurality of first nanostructures provided in the first meta-lens, the second meta-lens may have a negative focal length based on the plurality of first nanostructures provided in the second meta-lens, the first meta-mirror may have a negative focal length based on the plurality of second nanostructures provided in the first meta-mirror, and the second meta-mirror may have a positive focal length based on the plurality of second nanostructures provided in the second meta-mirror.

The first meta-lens and the first meta-mirror may be configured such that the first light beam is reflected by the first meta-mirror, and the first light beam that has been reflected by the first meta-mirror is transmitted through the first meta-lens, and the second meta-lens and the second meta-mirror may be configured such that the second light beam is reflected by the second meta-mirror, and the second light beam that has been reflected by the second meta-mirror is transmitted through the second meta-lens.

The first meta-lens and the first meta-mirror may be configured such that the first light beam is transmitted through the first meta-lens, and the first light beam that has been transmitted through the first meta-lens is reflected by the first meta-mirror, and the second meta-lens and the second meta-mirror may be configured such that the second light beam is transmitted through the second meta-lens, and the second light beam that has been transmitted through the second meta-lens is reflected by the second meta-mirror.

At least one of the plurality of first nanostructures and the plurality of second nanostructures may include a first-layer nanostructure and a second-layer nanostructure provided on the first-layer nanostructure, the second-layer nanostructure may have an asymmetric cross-section in which a major axis and a minor axis are defined, and an arrangement angle of the major axis may be arranged differently according to a relative position of the second-layer nanostructure in the meta-lens.

Based on a shape distribution of the plurality of first nanostructures, at least one of the first meta-lens and the second meta-lens may be further configured to deflect the incident light and emit the deflected incident light.

The first meta-lens may be an annular region with an outer radius r1 and an inner radius r2; and the second meta-lens may be an annular region with an outer radius r3 and an inner radius r4. The first meta-mirror may be an annular region with an outer radius r5 and an inner radius r6; and the second meta-mirror may be an annular region with an outer radius r7 and an inner radius r8, wherein r1>r2>r5>r6>r7>r8>r3>r4.

The first meta-lens may include a first first meta-lens and a second first meta-lens, the second meta-lens may include a first second meta-lens and a second second meta-lens, the first first meta-lens, the first second meta-lens, the second second meta-lens, and the second first meta-lens are sequentially spaced apart from each other, the first meta-mirror may include a first first meta-mirror and a second first meta-mirror, the second meta-mirror may include a first second meta-mirror and a second second meta-mirror, the first first meta-mirror, the first second meta-mirror, the second second meta-mirror, and the second first meta-mirror are sequentially spaced apart from each other, and each of the first first meta-lens, the first second meta-lens, the second second meta-lens, and the second first meta-lens has a rectangular shape.

The processor may be further configured to analyze at least one of a misalignment state between the first structure and the second structure in a direction perpendicular to an optical axis based on the interference pattern and a distance between the first structure and the second structure in an optical axis direction.

An optical path switching member arranged in an optical path between the imaging device and the first structure to change a path of light that has transmitted through the meta-lens to head towards the imaging device may be further included.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a perspective view illustrating a schematic structure of an align key according to an embodiment;

FIG. 2 is a plan view showing a schematic structure of a meta-lens provided in the align key of FIG. 1 according to an embodiment;

FIG. 3 is a plan view showing a schematic structure of a meta-mirror provided in the align key of FIG. 1 according to another embodiment;

FIG. 4 is a conceptual diagram illustrating an example of an operation of an align key according to an embodiment;

FIG. 5 is a diagram illustrating an optical path by an equivalent optical system of a first meta-lens-first meta-mirror pair in an example case in which a meta-lens and a meta-mirror are aligned;

FIG. 6 is a diagram illustrating an optical path by an equivalent optical system of a second meta-lens-second meta-mirror pair in an example case in which a meta-lens and a meta-mirror are aligned;

FIG. 7 is a diagram illustrating an optical path by an equivalent optical system of a first meta-lens-first meta-mirror pair in an example case in which a meta-lens and a meta-mirror are misaligned in an X axis;

FIG. 8 is a diagram illustrating an optical path by an equivalent optical system of a second meta-lens-second meta-mirror pair in an example case in which a meta-lens and a meta-mirror are misaligned in an X axis;

FIG. 9 is a diagram illustrating an optical path by an equivalent optical system of a first meta-lens-first meta-mirror pair in an example case in which a distance between a meta-lens and a meta-mirror in a Z direction deviates from a reference distance;

FIG. 10 is a diagram illustrating an optical path by an equivalent optical system of a second meta-lens-second meta-mirror pair in an example case in which a distance between a meta-lens and a meta-mirror in a Z direction deviates from a reference distance;

FIGS. 11A-11D show computer-simulated diagrams of interference patterns in which light transmitted through an align key is imaged by an imaging device according to the degree to which a meta-lens and a meta-mirror are misaligned in an X direction;

FIGS. 12A-12D show computer-simulated diagrams of interference patterns in which light transmitted through an align key is imaged by an imaging device according to the degree to which a distance between a meta-lens and a meta-mirror deviates from a reference distance;

FIG. 13 is a view illustrating a schematic structure of an align key according to another embodiment;

FIGS. 14A-14C computer-simulated diagrams of interference patterns in which light transmitted through the align key of FIG. 13 is imaged by an imaging device according to various alignment states of a meta-lens and a meta-mirror provided in the align key;

FIG. 15 is a perspective view illustrating a shape of a nanostructure provided in an align key according to an embodiment;

FIG. 16 is a perspective view illustrating a shape of a nanostructure provided in an align key according to another embodiment;

FIG. 17 is a perspective view illustrating shapes of nanostructures provided in an align key according to another embodiment;

FIG. 18 is a block diagram illustrating a schematic configuration of an aligning apparatus according to an embodiment;

FIG. 19 is a cross-sectional view illustrating a schematic structure of an apparatus including an align key according to an embodiment; and

FIGS. 20 to 22 are diagrams schematically illustrating examples in which an align key is used according to embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Hereinafter, embodiments are described in detail with reference to the accompanying drawings. Embodiments described below are merely illustrative, and various modifications are possible from these embodiments. In the following drawings, the same reference numerals refer to the same components, and the size of each component in the drawings may be exaggerated for clarity and convenience of description.

Hereinafter, the term “upper portion” or “on” may also include “to be present above on a non-contact basis” as well as “to be present just on the top portion on a directly contact basis”.

The terms first, second, etc. may be used to describe various components, but are used only for the purpose of distinguishing one component from another component. These terms do not limit the difference in material or structure of components.

Singular expressions include plural expressions unless they are explicitly meant differently in context. In addition, when a part “includes” a component, this means that it may include more other components, rather than excluding other components, unless otherwise stated.

Further, the terms “unit”, “module” or the like mean a unit that processes at least one function or operation, which may be implemented in hardware or software or implemented in a combination of hardware and software.

The use of the term “the” and similar indicative terms may correspond to both singular and plural.

Operations constituting the method may be performed in an appropriate order unless there is a clear statement that the operations should be performed in a specified order as described. In addition, the use of all illustrative terms (e.g., etc.) is simply intended to detail technical ideas and, unless limited by the claims, the scope of rights is not limited due to the terms.

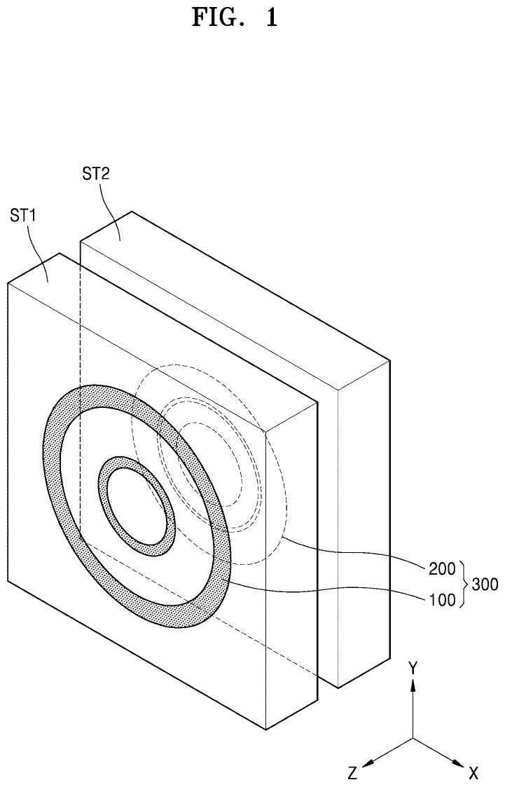

FIG. 1 is a perspective view illustrating a schematic structure of an align key according to an embodiment.

Referring to FIG. 1, an align key 300 includes a meta-lens 100 and a meta-mirror 200. The meta-lens 100 and the meta-mirror 200 may be arranged in structures to be aligned and bonded into one package by using the align key. For example, the meta-lens 100 and the meta-mirror 200 may be arranged in separate structures to be aligned and bonded into one package by using the align key. For example, the meta-lens 100 may be provided in a first structure ST1, and the meta-mirror 200 may be provided in a second structure ST2. The meta-lens 100 and the meta-mirror 200 may be spaced apart from each other and arranged to face each other. According to an embodiment, each of the first structure ST1 and the second structure ST2 may include, but is not limited to, a metal pattern, an insulating pattern, a semiconductor pattern, and the like constituting electronic devices. For example, the metal pattern, the insulating pattern, the semiconductor pattern, and/or the like constituting electronic devices to be integrated using the align key 300 may be arranged on each of the first structure ST1 and the second structure ST2, and such a structure is omitted in the drawing for convenience.

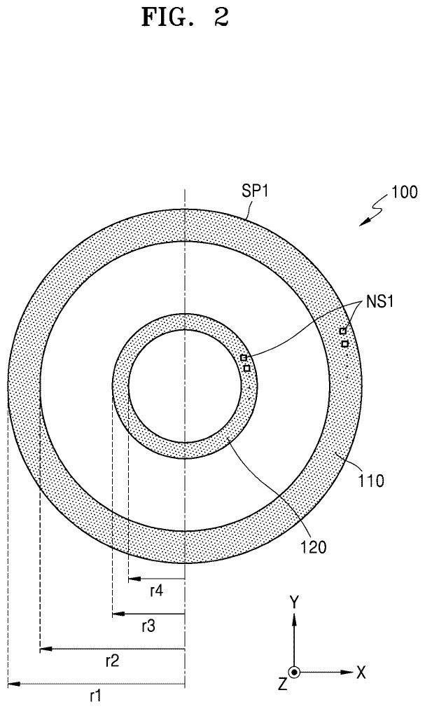

FIG. 2 is a plan view showing a schematic structure of a meta-lens provided in an align key according to an embodiment.

The meta-lens 100 may include a first meta-lens 110 and a second meta-lens 120. The first meta-lens 110 may be an annular region having an outer radius r1 and an inner radius r2 from the center, and the second meta-lens 120 may be an annular region having an outer radius r3 and an inner radius r4 from the center. Here, r1, r2, r3, and r4 may be positive numbers having a relationship of r1>r2>r3>r4.

Each of the first meta-lens 110 and the second meta-lens 120 may include a plurality of first nanostructures NS1. A focal length of each of the first meta-lens 110 and the second meta-lens 120 may be determined by the shape and arrangement of the plurality of first nanostructures NS1. The plurality of first nanostructures NS1 are arranged on a first support layer SP1. The shape and/or the arrangement of the plurality of first nanostructures NS1 may be configured to form focal lengths of opposite signs in different regions on the first support layer SP1. For example, the plurality of first nanostructures NS1 provided in the first meta-lens 110 may be provided such that the first meta-lens 110 operates as a converging lens having a positive focal length, and the plurality of first nanostructures NS1 provided in the second meta-lens 120 may be provided such that the second meta-lens 120 operates as a diverging lens having a negative focal length. For example, a width of the plurality of first nanostructures NS1 may decrease in the direction of increasing the radius of the first meta-lens 110 so that the plurality of first nanostructures NS1 provided in the first meta-lens 110 may have a positive focal length, and the width of the plurality of first nanostructures NS1 may increase in the direction of increasing the radius of the second meta-lens 120 so that the plurality of first nanostructures NS1 provided in the second meta-lens 120 may have a negative focal length. For example, the plurality of first nanostructures NS1 may have a columnar shape or a pillar shape, and the width of the plurality of first nanostructures NS1 may refer to a width of the column or the pillar.

The first support layer SP1 may include a material having a refractive index different from a refractive index of the first nanostructure NS1. The first support layer SP1 may be provided to support the first nanostructure NS1 in a configuration that is separate from the first structure ST1 shown in FIG. 1, or may be a partial configuration of the first structure ST1.

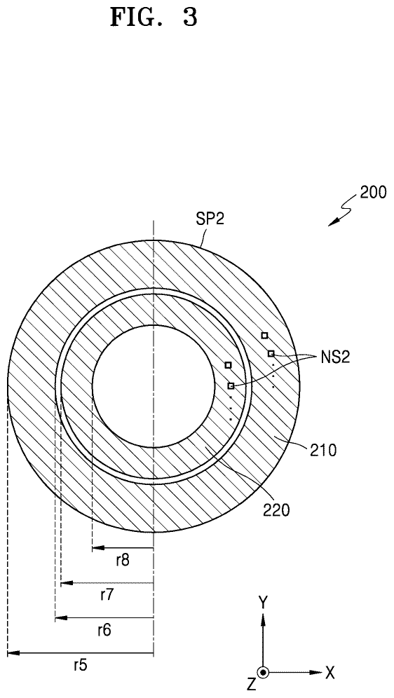

FIG. 3 is a plan view showing a schematic structure of a meta-mirror provided in an align key according to another embodiment.

The meta-mirror 200 may include a first meta-mirror 210 and a second meta-mirror 220. The first meta-mirror 210 may be an annular region having an outer radius r5 and an inner radius r6 from the center, and the second meta-mirror 220 may be an annular region having an outer radius r7 and an inner radius r8 from the center. Here, r5, r6, r7, and r8 may be positive numbers having a relationship of r5>r6>r7>r8.

In addition, r1, r2, r3, and r4 in FIGS. 2 and r5, r6, r7, and r8 in FIG. 3 may satisfy a relationship of r1>r2>r5>r6>r7>r8>r3>r4. For example, r1 may be approximately 150 μm, r2 may be approximately 131 μm, r3 may be approximately 65 μm, r4 may be approximately 39 μm, r5 may be approximately 130 μm, r6 may be approximately 113 μm, r7 may be approximately 112 μm, and r8 may be approximately 68 μm.

Each of the first meta-mirror 210 and the second meta-mirror 220 may include a plurality of second nanostructures NS2. The plurality of second nanostructures NS2 are arranged on a second support layer SP2. The shape and/or the arrangement of the plurality of second nanostructures NS2 may be configured to form focal lengths of opposite signs in different regions on the second support layer SP2. For example, the plurality of second nanostructures NS2 provided in the first meta-mirror 210 may be provided such that the first meta-mirror 210 operates as a diverging mirror having a negative focal length, and the plurality of second nanostructures NS2 provided in the second meta-mirror 220 may be provided such that the second meta-mirror 220 operates as a converging mirror having a positive focal length.

The second support layer SP2 may include a material having a refractive index different from a refractive index of the second nanostructure NS2. The second support layer SP2 may be provided to support the second nanostructure NS2 in a configuration separate from the second structure ST2 shown in FIG. 1, or may be a partial configuration of the second structure ST2.

The shape and arrangement of the first nanostructure NS1 provided in the meta-lens 100 or the second nanostructure NS2 provided in the meta-mirror 200 may be set to form a phase profile capable of representing a reference refractive power with respect to incident light. The reference refractive power may be a predetermined refractive power and/or a desired refractive power. The phase profile is a phase profile that is based on the meta-lens and the meta-mirror that implements a positive focal length or a negative focal length as described above. The phase profile varies depending on the shape, size, and arrangement of the nanostructures. In other words, a detailed shape, size, and arrangement of the first nanostructure NS1 and the second nanostructure NS2 set for each location may be determined according to a desired phase profile.

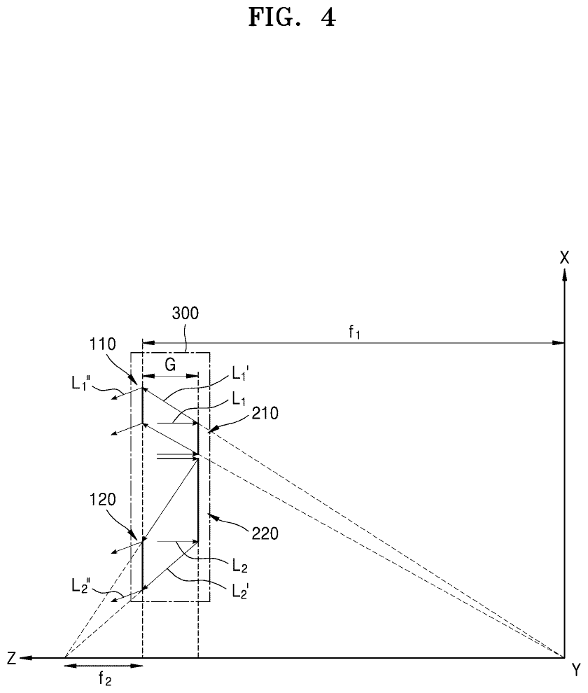

FIG. 4 is a conceptual diagram illustrating an example of an operation of an align key according to an embodiment.

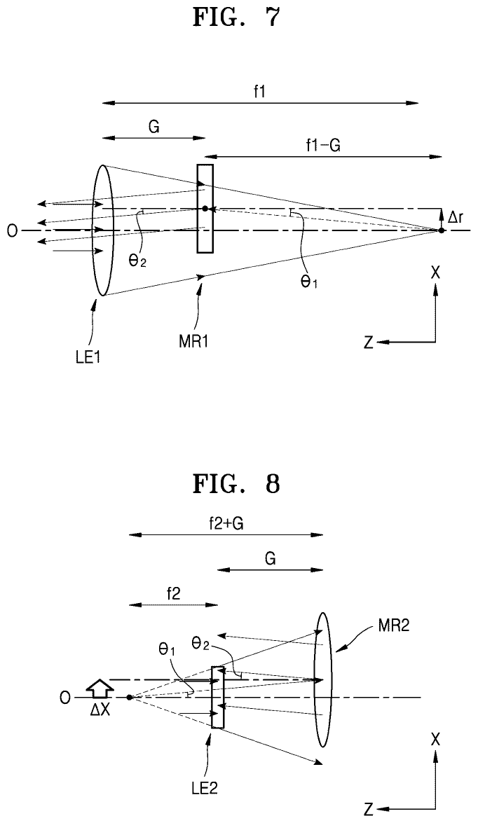

Referring to FIG. 4, the meta-lens 100 and the meta-mirror 200 may be spaced apart from each other at a constant separation distance G in the Z direction to face each other. For example, the first meta-lens 110 and the second meta-lens 120 may be spaced apart from the first meta-mirror 210 and the second meta-mirror 220 by distance G in the Z direction. The separation distance G may be, for example, approximately 30 μm, the focal length f1 of the first meta-lens 110 may be approximately 222 μm, and the focal length f2 of the second meta-lens 120 may be approximately 40 μm. The angle θ₁ (see FIG. 7) formed by the focus of the first meta-lens 110 and the inner diameter of the first meta-lens 110 may be about 34 degrees. The angle θ₂ (see FIG. 7) formed by the focus of the second meta-lens 120 and the outer diameter of the second meta-lens 120 may be about 58 degrees.

Some portions of the light beams output from the light source (e.g., the first light beam L₁) may enter the first meta-mirror 210, and some other portions of the light output from the light source (e.g., the second light beam L₂) may enter the second meta-mirror 220.

The first light beam L₁ may be incident on the first meta-mirror 210 having a negative focal length −(f₁-G) and then reflected by the first meta-mirror 210 to be incident as the first light beam L₁′ on the first meta-lens 110, and the first light beam L₁′incident on the first meta-lens 110 may pass through the first meta-lens 110 having the positive focal length f₁ to be refracted with positive refractive power and be directed to the imaging device as the first light beam L₁″.

The second light beam L₂ may be incident on the second meta-mirror 220 having a positive focal length (f₂+G) and then reflected by the second meta-mirror 220 to be incident as the first light beam L₂′ on the second meta-lens 120, and the second light beam L₂′ incident on the second meta-lens 120 may pass through the second meta-lens 120 having the negative focal length −f₂ to be refracted with negative refractive power and be directed to the imaging device as the second light beam L₂″.

In an example case in which the meta-lens 100 and the meta-mirror 200 are not aligned, for example, misaligned in the X direction or Y direction, or in an example case in which the distance between the meta-lens 100 and the meta-mirror 200 in the Z direction is out of the reference distance, the interference pattern of the first light beam L₁″ and the second light beam L₂″ transmitted and reflected by the align key 300 may vary. Therefore, it is possible to determine whether the meta-lens 100 and the meta-mirror 200 are aligned, the degree of misalignment between the meta-lens 100 and the meta-mirror 200 in the X or Y direction, or the degree of deviation from the reference distance in the Z direction from the interference pattern of the first light beam L₁″ and the second light beam L₂″ transmitted and reflected by the align key 300.

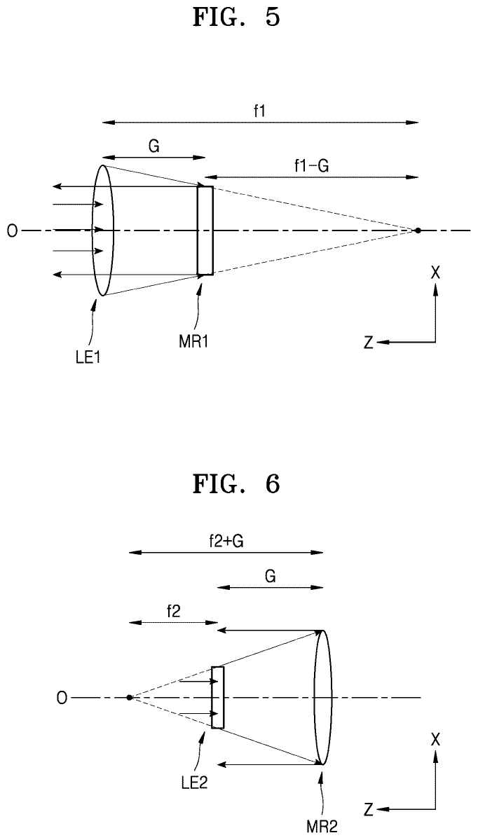

Hereinafter, an optical path according to an alignment state of the first meta-lens 110-first meta-mirror 210 pair and the second meta-lens 120-second meta-mirror 220 pair is described. In FIGS. 5 to 10, the first meta-lens 110 and the first meta-mirror 210 are displayed as a first lens LE1 that is a convergent lens and a first mirror MR1 that is a divergent mirror, respectively, and the second meta-lens 120 and the second meta-mirror 220 are displayed as a first lens LE2 that is a divergent lens and a second mirror MR2 that is a convergent mirror, respectively.

FIG. 5 is a diagram illustrating an optical path by an equivalent optical system of a first meta-lens 110 and first meta-mirror 210 pair in an example case in which a meta-lens 100 and a meta-mirror 200 are aligned. FIG. 6 is a diagram illustrating an optical path by an equivalent optical system of a second meta-lens 120 and second meta-mirror 220 pair in an example case in which a meta-lens 100 and a meta-mirror 200 are aligned.

Referring to FIG. 5, in an example case in which the first meta-lens 110 and first meta-mirror 210 pair is accurately aligned, a line connecting the center of the first lens LE1 in the equivalent relationship with the first meta-lens 110 with the center of the first mirror MR1 in the equivalent relationship with the first meta-mirror 210 may be parallel to the optical axis O. Although FIG. 4 shows the case where the incident light is first reflected by the meta-mirror 200 and then transmitted through the meta-lens 100, as shown in FIG. 5, the incident light may first pass through and converge through the first lens LE1 having a focal length f₁ to enter the first mirror MR1, and the light incident on the first mirror MR1 is reflected and diverged to proceed in a direction parallel to the optical axis O. Additionally, as shown in FIG. 6, the incident light first passes through and diverges through the second lens LE2 having a focal length −f₂ to enter the first mirror MR1, and the light incident on the first mirror MR1 is reflected and converged to proceed in a direction parallel to the optical axis O.

FIG. 7 is a diagram illustrating an optical path by an equivalent optical system of a first meta-lens 110 and first meta-mirror 210 pair in an example case in which a meta-lens 100 and a meta-mirror 200 are misaligned in an X axis. FIG. 8 is a diagram illustrating an optical path by an equivalent optical system of a second meta-lens 120 and second meta-mirror 220 pair in an example case in which a meta-lens 100 and a meta-mirror 200 are misaligned in an X axis.

Referring to FIG. 7, in an example case in which the first meta-lens 110 and first meta-mirror 210 pair is misaligned in the X-axis direction, a line connecting the center of the first lens LE1 in the equivalent relationship with the first meta-lens 110 to the center of the first mirror MR1 in the equivalent relationship with the first meta-mirror 210 may not be parallel to the optical axis O. In an example case in which the first mirror MR1 deviates from the optical axis O by AX in the X-axis direction, an angle Δ₁ formed by a line connecting the focus of the first lens LE1 to the center of the first mirror MR1 and the optical axis O may be greater than zero (0). Accordingly, light incident on the first lens LE1 in a direction parallel to the optical axis O may be reflected by the first mirror MR1 and travel to form a certain angle θ₂ with the optical axis O.

Similarly, referring to FIG. 8, in an example case in which the second meta-lens 120 and second meta-mirror 220 pair is misaligned in the X-axis direction, a line connecting the center of the second lens LE2 in an equivalent relationship with the second meta-lens 120 to the center of the second mirror MR2 in an equivalent relationship with the second meta-mirror 220 may not be parallel to the optical axis O. In an example case in which the second mirror MR2 deviates from the optical axis O by ΔX in the X-axis direction, an angle θ₁′ formed by a line connecting the focus of the second lens LE2 to the center of the second mirror MR2 and the optical axis O may be greater than zero (0). Accordingly, light incident on the second lens LE2 in a direction parallel to the optical axis O may be reflected by the second mirror MR2 and travel to form a certain angle θ₂′ with the optical axis O.

As described above, the optical path by the first meta-lens 110 and first meta-mirror 210 pair shown in FIG. 7 is different from the optical path by the first meta-lens 110 and first meta-mirror 210 pair shown in FIG. 5, and the optical path by the second meta-lens 120 and second meta-mirror 220 pair shown in FIG. 8 is different from the optical path by the second meta-lens 120 and second meta-mirror 220 pair shown in FIG. 6. Therefore, it is possible to determine the misalignment in the lateral direction (e.g., X or Y direction) by analyzing the interference pattern according to the optical path change by the first meta-lens 110 and first meta-mirror 210 pair and the second meta-lens 120 and second meta-mirror 220 pair.

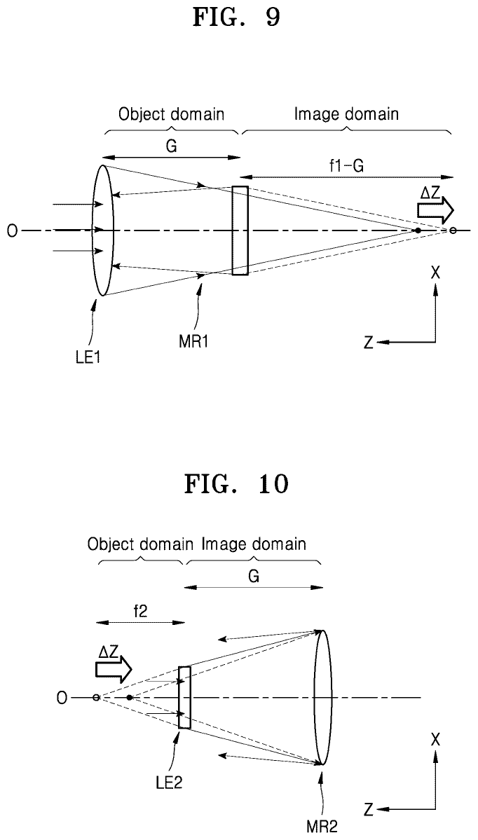

FIG. 9 is a diagram illustrating an optical path by an equivalent optical system of a first meta-lens 110 and first meta-mirror 210 pair in an example case in which a distance between a meta-lens 100 and a meta-mirror 200 in a Z direction deviates from a reference distance G. FIG. 10 is a diagram illustrating an optical path by an equivalent optical system of a second meta-lens 120 and second meta-mirror 220 pair in an example case in which a distance between a meta-lens 100 and a meta-mirror 200 in a Z direction deviates from a reference distance G.

Referring to FIG. 9, in an example case in which the distance in the first meta-lens 110 and first meta-mirror 210 pair is out of the reference distance G by AZ, light incident on the first lens LE1 in a direction parallel to the optical axis O is reflected by the first mirror MR1 and may travel in a direction not parallel to the optical axis O.

Likewise, referring to FIG. 10, in an example case in which the distance in the second meta-lens 120 and second meta-mirror 220 pair is out of the reference distance G by AZ, light incident on the second lens LE2 in a direction parallel to the optical axis O is reflected by the second mirror MR2 and may travel in a direction not parallel to the optical axis O.

As described above, the optical path by the first meta-lens 110 and first meta-mirror 210 pair shown in FIG. 9 is different from the optical path by the first meta-lens 110 and first meta-mirror 210 pair shown in FIG. 5, and the optical path by the second meta-lens 120 and second meta-mirror 220 pair shown in FIG. 10 is different from the optical path by the second meta-lens 120 and second meta-mirror 220 pair shown in FIG. 6. Therefore, it is possible to determine the misalignment in the optical axis direction (e.g., Z direction) by analyzing the interference pattern according to the optical path change by the first meta-lens 110-first meta-mirror 210 pair and the second meta-lens 120-second meta-mirror 220 pair. The interference pattern along the optical path may be measured using an imaging device.

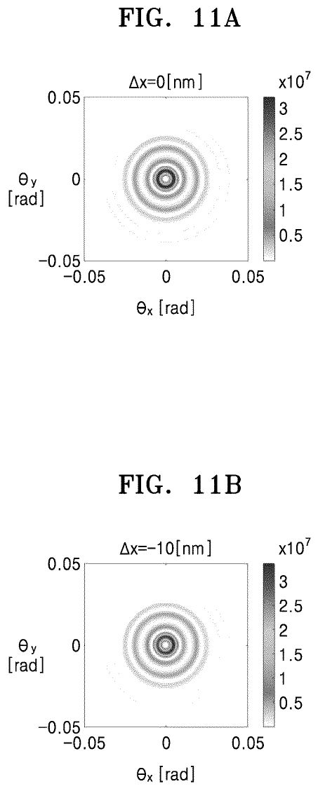

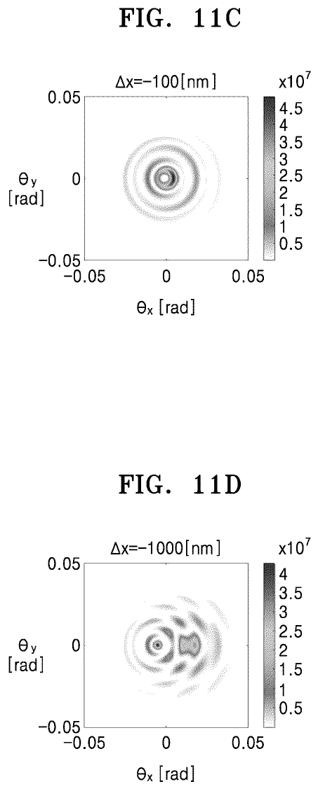

FIGS. 11A-11D show computer-simulated diagrams of interference patterns in which light transmitted through an align key is imaged by an imaging device according to the degree to which a meta-lens and a meta-mirror are misaligned in an X direction.

For example, FIG. 11A illustrates an interference pattern in a state in which the meta-lens 100 and the meta-mirror 200 are aligned, and FIG. 11B illustrates an interference pattern in a state in which the meta-lens 100 and the meta-mirror 200 are misaligned by −10 nm in the X direction, from which the lateral misalignment state can be determined. Referring to FIGS. 11A and 11B, the interference pattern in FIG. 11A is different from the interference pattern in FIG. 11B. FIG. 11C illustrates an interference pattern in a state in which the meta-lens 100 and the meta-mirror 200 are misaligned by −100 nm in the X direction, and FIG. 11D illustrates an interference pattern in a state in which the meta-lens 100 and the meta-mirror 200 are misaligned by −1000 nm in the X direction. Referring to FIGS. 11A, 11C and 11D, the interference pattern in FIG. 11A is different from the interference patterns in FIGS. 11C and 11D. Also, the shape of the interference pattern changes similarly to the double slit interference pattern as the degree of misalignment increases. Accordingly, the degree of lateral misalignment between the meta-lens 100 and the meta-mirror 200 may be determined.

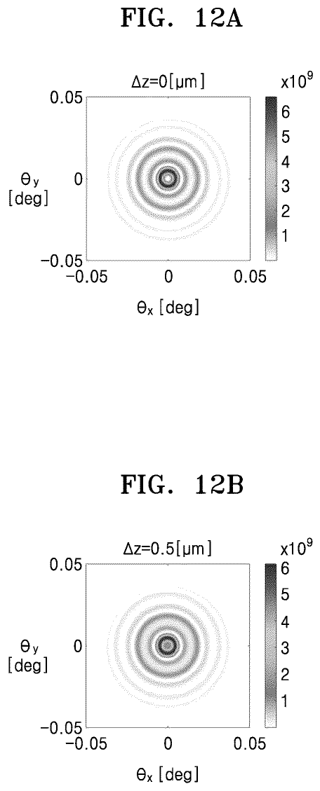

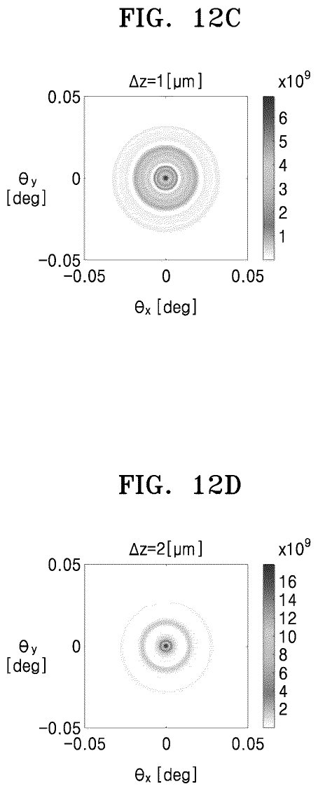

FIGS. 12A-12D show computer-simulated diagrams of interference patterns in which light transmitted through an align key is imaged by an imaging device according to the degree to which a distance between a meta-lens and a meta-mirror deviates from a reference distance.

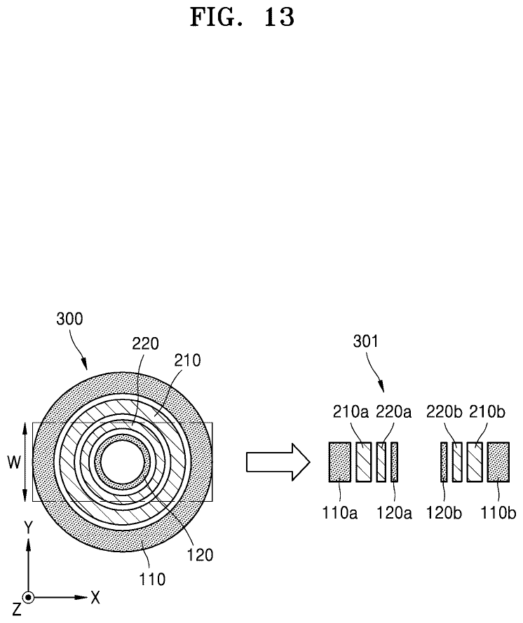

FIGS. 12A illustrates an interference pattern in a state in which the meta-lens 100 and the meta-mirror 200 are spaced apart from each other by a reference distance, and FIGS. 12B illustrates an interference pattern in a state in which the meta-lens 100 and the meta-mirror 200 deviate by 0.5 μm in the Z direction from the reference distance. Referring to FIGS. 12A and 12B, the interference pattern in FIG. 12A is different from the interference pattern in FIG. 12B. Accordingly, it may be determined that the meta-lens 100 and the meta-mirror 200 deviate from the reference distance. FIG. 12C illustrates an interference pattern in a state in which the meta-lens 100 and the meta-mirror 200 deviate by 1 μm in the Z direction from the reference distance, and FIG. 12D illustrates an interference pattern in a state in which the meta-lens 100 and the meta-mirror 200 deviate by 2 μm in the Z direction from the reference distance. Referring to FIGS. 12A, 12C and 12D, the interference pattern in FIG. 12A is different from the interference patterns in FIGS. 12C and 12D. Also the distance between the interference patterns changes in a case in which a distance of deviation from the reference distance increases. Accordingly, a separation distance between the meta-lens 100 and the meta-mirror 200 in the Z-direction may be determined. FIG. 13 is a view illustrating a schematic structure of an align key according to another embodiment.

Referring to FIG. 13, an align key 301 may have a structure obtained by truncating the align key 300 of FIG. 1. For example, the align key 301 may have a structure in which the align key 300 of FIG. 1 is cut by a predetermined width W in the X direction.

The align key 301 may include a first first meta-lens 110a and a second first meta-lens 110b in a form in which the first meta-lens 110 is cut. In addition, the align key 301 may include a first second meta-lens 120a and a second second meta-lens 120b in a form in which the second meta-lens 120 is cut. Each of the first first meta-lens 110a, the first second meta-lens 120a, the second second meta-lens 120b, and the second first meta-lens 110b may have an approximately rectangular shape. The first first meta-lens 110a, the first second meta-lens 120a, the second second meta-lens 120b, and the second first meta-lens 110b may be sequentially provided on the first structure ST1 of FIG. 1 to be spaced apart from each other in the X direction.

In addition, the align key 301 may include a first first meta-mirror 210a and a second first meta-mirror 210b in a form in which the first meta-mirror 210 is cut, and the align key 301 may include a first second meta-mirror 220a and a second second meta-mirror 220b in a form in which the second meta-mirror 220 is cut. Each of the first first meta-mirror 210a, the first second meta-mirror 220a, the second second meta-mirror 220b, and the second first meta-mirror 210b may have an approximately rectangular shape. The first first meta-mirror 210a, the first second meta-mirror 220a, the second second meta-mirror 220b, and the second first meta-mirror 210b may be sequentially provided on the second structure ST2 of FIG. 1 to be spaced apart from each other in the X direction.

However, the disclosure is not limited thereto, and as such, the align key 301 may be implemented to have other symmetrical shapes. For example, the align key 301 may be implemented to have cylindrical symmetry with respect to a kind of Y-axis such that refraction and transmission reflection are performed only in the X direction, rather than cutting the align key 300 including the circular first and second meta-lenses 110 and 120 and the first and second meta-mirrors 210 and 220 of FIG. 1.

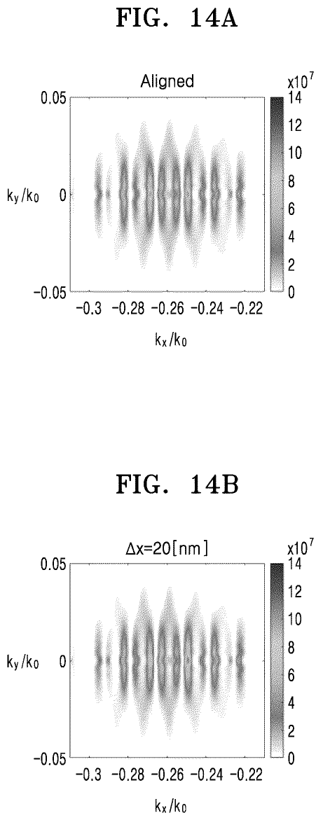

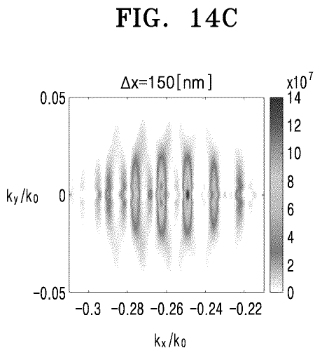

FIGS. 14A-14C show computer-simulated diagrams of interference patterns in which light transmitted through the align key of FIG. 13 is imaged by an imaging device according to various alignment states of a meta-lens and a meta-mirror provided in the align key 301 of FIG. 13.

FIG. 14A illustrates an interference pattern corresponding to a form in which the align key 301 of FIG. 13 is aligned, FIG. 14B illustrates an interference pattern corresponding to a form in which the align key 301 of FIG. 13 is misaligned by 20 nm in the X direction, and FIG. 14C illustrates an interference pattern corresponding to a form in which the align key 301 of FIG. 13 is misaligned by 150 nm in the X direction. The interferences patterns in FIGS. 14A, 14B and 14C appear differently, and from this, the X-direction misalignment state may be more precisely determined.

Hereinafter, the first nanostructure NS1 and the second nanostructure NS2 (hereinafter, a nanostructure NP) provided in the align keys 300 and 301 are described.

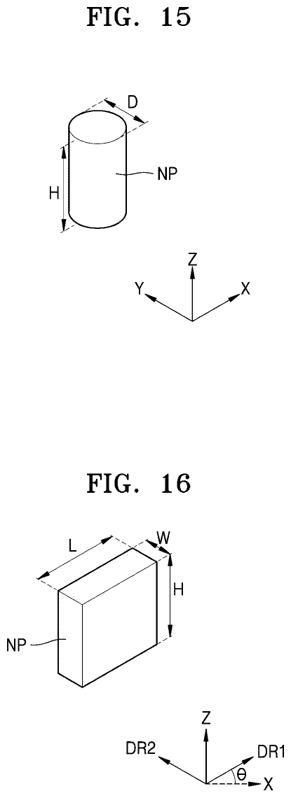

FIG. 15 illustrates a shape of a nanostructure provided in an align key according to an embodiment.

Referring to FIG. 15, the nanostructure NP may have a cylindrical shape having a diameter D and a height H. D may be set differently according to a relative position where the nanostructure NP is provided in the meta-lens 100. As described above, a desired phase profile may be implemented by adjusting the size of the nanostructure NP according to the position of the nanostructure NP.

The nanostructure NP may have a shape dimension of a sub-wavelength. For example, the nanostructure NP may have a shape dimension smaller than a center wavelength of an operating wavelength band. For example, the diameter D of the nanostructure NP or the arrangement pitch of the nanostructures NP may be a sub-wavelength, or ⅔ or less of the center wavelength of the operating wavelength band. The height H of the nanostructure NP may have a range of a sub-wavelength or more, for example, a height of ⅙ or more of the center wavelength.

The nanostructure NP may include a metal or a material having a high refractive index. The nanostructure NP may include Cu, W, or TiN, or various other metal materials, or may include c-Si, p-Si, a-Si, III-V compound semiconductors (GaAs, GaP, GaN, etc.), SiC, TiO₂, or SiN. The nanostructures NP provided in the first meta-lens 110 and the second meta-lens 120 may include the same material. According to another embodiment, the nanostructures NP provided in the first meta-lens 110 and the second meta-lens 120 may include materials different from each other. In addition, the nanostructures NP provided in the first meta-mirror 210 and the second meta-mirror 220 may include the same material. According to another embodiment, the nanostructures NP provided in the first meta-mirror 210 and the second meta-mirror 220 may include different materials.

The nanostructure NP provided in the meta-lens 100 may be additionally configured such that at least one of the first meta-lens 110 and the second meta-lens 120 has optical performance of deflecting incident light. For example, the first nanostructure NS1 provided in the meta-lens 100 may be provided to have a phase profile capable of deflecting light subjected to a refractive force action in a predetermined direction and emitting the deflected light.

FIG. 16 illustrates a shape of a nanostructure provided in an align key according to another embodiment.

Referring to FIG. 16, the nanostructure NP may have a polygonal pillar shape. For example, the nanostructure NP may have a pillar shape having an asymmetric cross section in which a major axis and a minor axis are independently defined. In FIG. 16, the major axis direction and the minor axis direction of the nanostructure NP are represented by DR1 and DR2, respectively. For example, the nanostructure NP may have a rectangular pillar shape having a major axis L, a minor axis W, and a height H.

For example, the nanostructures NP provided in the meta-lens 100 all have the same size, and the arrangement angle θ of the major axis may be arranged differently depending on the relative position of the nanostructures NP in the meta-lens 100 where. In addition, the nanostructures NP provided in the meta-mirror 200 all have the same size, and the arrangement angle θ of the major axis may be arranged differently depending on the relative position of the nanostructures NP in the meta-mirror 200. As described above, a desired phase profile may be implemented by adjusting the arrangement angle of the nanostructure NP according to the position of the nanostructure NP in the meta-lens 100 or the meta-mirror 200.

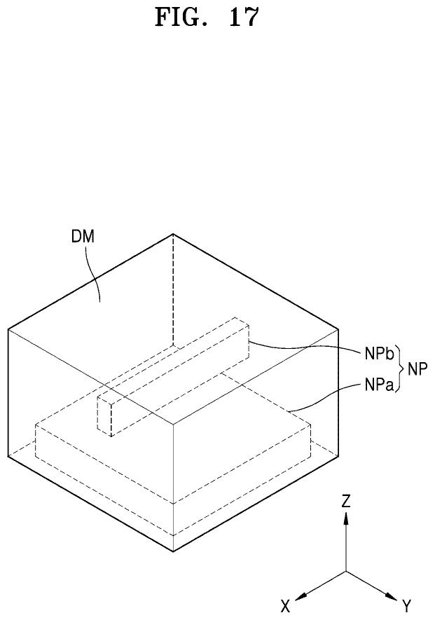

FIG. 17 illustrates shapes of nanostructures provided in an align key according to another embodiment.

The nanostructure NP may include multilayered nanostructures NPa and NPb. For example, each nanostructure NP may include a first-layer nanostructure NPa and a second-layer nanostructure NPb provided on the first-layer nanostructure NPa described above. The first-layer nanostructure NPa and the second-layer nanostructure NPb may be provided in the dielectric material DM. The first-layer nanostructure NPa and the second-layer nanostructure NPb may include the same material. According to another embodiment, the first-layer nanostructure NPa and the second-layer nanostructure NPb may include materials different from each other. For example, the first-layer nanostructure NPa may include W, and the second-layer nanostructure NPb may include Cu.

The first-layer nanostructure NPa and the second-layer nanostructure NPb may have different shapes. For example, the first-layer nanostructure NPa may have a rectangular pillar shape having a rectangular cross section, and the second-layer nanostructure NPb may have a rectangular pillar shape having an asymmetric cross section in which a major axis and a minor axis are defined, respectively. For example, the second-layer nanostructure NPb may have a rectangular pillar shape having a major axis L, a minor axis W, and a height H, as shown in FIG. 16. In addition, as described in FIG. 16, the arrangement angle θ of the major axis may be arranged differently depending on the relative position of the second-layer nanostructure NPb within the meta-lens 100 or meta-mirror 200. In this way, a desired phase profile may be implemented by adjusting the arrangement angle of the second-layer nanostructure NPb according to the position.

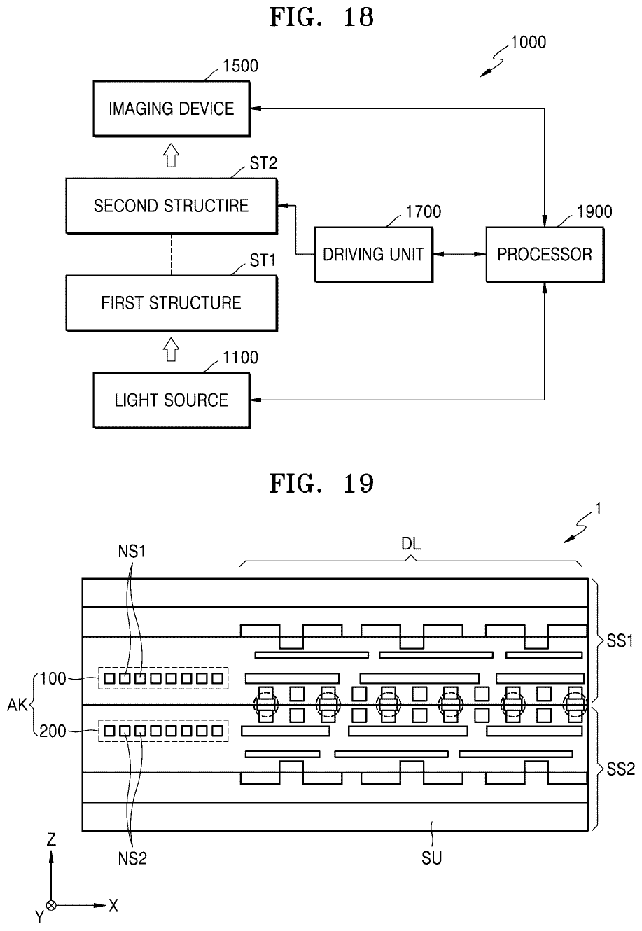

FIG. 18 is a block diagram illustrating a schematic configuration of an aligning apparatus according to an embodiment.

Referring to FIG. 18, an aligning apparatus 1000 according to an embodiment may include align keys of various examples described above. The meta-lens and the meta-mirror constituting the align key may be divided and arranged in two structures coupled to each other. The aligning apparatus 1000 may also include a light source that irradiates light to the align key and an imaging device that measures an interference pattern transmitted through the align key.

For example, the aligning apparatus 1000 may include a light source 1100, a first structure ST1 including a meta-lens 100, a second structure ST2 including a meta-mirror 200, an imaging device 1500, a processor 1900 and a driving unit 1700. The imaging device 1500 may be configured to measure an interference pattern of light beams after passing through the meta-lens 100 and the meta-mirror 200. The processor 1900 may be configured to analyze a degree of misalignment between the first structure ST1 and the second structure ST2 according to a measurement result by the imaging device 1500. The driving unit 1700 may be configured to move any one of the first structure ST1 and the second structure ST2 according to control by the processor 1900.

The imaging device 1500 measures interference patterns of light beams transmitted and reflected by the first meta-lens 110 of the meta-lens 100 and the first meta-mirror 210 of the meta-mirror 200, and light beams transmitted and reflected by the second meta-lens 120 of the meta-lens 100 and the second meta-mirror 220 of the meta-mirror 200, and may include one or more lenses and an image sensor. For example, the imaging device 1500 may be provided in the same direction as the direction in which the light source 1100 is provided with respect to the align key 300. An optical path switching member for converting the path of the light beam transmitted through the meta-lens 100 toward the image sensor may be further included between the imaging device 1500 and the first structure ST1. The optical path switching member is for convenience of arrangement of the imaging device 1500 and may be omitted.

The processor 1900 may analyze an alignment state between the first structure ST1 and the second structure ST2 from the measurement result of the imaging device 1500. In an example case in which the first structure ST1 and the second structure ST2 are spaced apart in the Z direction, the processor 1900 may analyze not only the degree of misalignment in the X and Y directions, but also the distance in the Z direction. The processor 1900 may control the driving unit 1700 according to the analyzed result. The processor 1900 may also control overall driving of the aligning apparatus 1000.

The driving unit 1700 may change a relative positional relationship between the first structure ST1 and the second structure ST2 according to control by the processor 1900. For example, the first structure ST1 may be fixed, and the second structure ST2 may be placed on a driving stage, and the position of the second structure ST2 may be adjusted by the driving unit 1700. However, this is only an example, and it is also possible to adjust the position of the first structure ST1 by fixing the second structure ST2 and placing the first structure ST1 on the driving stage.

The aligning apparatus 1000 includes the align keys of the various examples described above, and may also analyze the misalignment state in the X and Y directions and the distance in the Z direction, thereby improving the accuracy of combining the first structure ST1 with the second structure ST2.

FIG. 19 is a cross-sectional view illustrating a schematic structure of an apparatus including an align key according to an embodiment.

Referring to FIG. 19, an apparatus 1 having an align key according to an embodiment includes a substrate SU and an align key AK arranged on the substrate SU. The align key AK includes a meta-lens 100 and a meta-mirror 200. For example, the align key AK includes a meta-lens 100 including first nanostructures NS1 and a meta-mirror 200 including second nanostructures NS2. The align key AK may include any one of the align keys 300 and 301 described above or a structure modified therefrom.

The align key AK is used to precisely combine two separately manufactured electronic devices. The align key AK may be divided into two parts and provided on two substrate structures SS1 and SS2 to be coupled. The apparatus 1 may be, for example, a structure in which the substrate structure SS1 having the meta-lens 100 and the substrate structure SS2 having the meta-mirror 200 are combined. In an example case in which the two substrate structures SS1 and SS2 are combined, the degree to which the two substrate structures SS1 and SS2 are misaligned in X and Y directions may be measured from the interference pattern after light is transmitted and reflected through the align key AK, and the distance in the Z direction between the two substrate structures SS1 and SS2 may also be measured. By reflecting the measurement result, the two substrate structures SS1 and SS2 may be aligned to a desired position, or a condition for bonding the two substrate structures SS1 and SS2 may be modified. The two substrate structures SS1 and SS2 are aligned to a desired position, and then, are directly bonded to each other. As illustrated by dotted circles, the two substrate structures SS 1 to SS 2 may be metal-bonded or hybrid bonded.

The apparatus 1 formed by combining the two substrate structures SS1 and SS2 with each other includes a device layer DL made of an insulating pattern, a semiconductor pattern, a metal pattern, and the like. The apparatus 1 may be various semiconductor devices, for example, a memory device, a logic device, an image sensor, an integrated circuit device, or the like, and may be a flat nanostructure-based optical device formed on a wafer substrate, and is not particularly limited thereto.

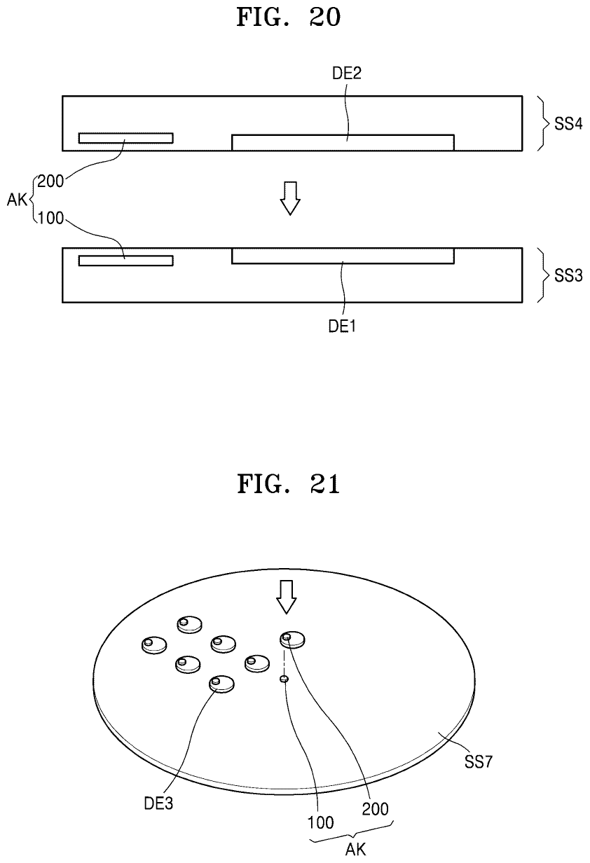

FIGS. 20 to 22 are diagrams schematically illustrating examples in which an align key is used according to embodiments.

Referring to FIG. 20, a face to face (F2F) bonding between two substrate structures SS3 and SS4 is illustrated. The substrate structure SS3 includes a device DE1 and a meta-lens 100, and the substrate structure SS4 includes a device DE2 and a meta-mirror 200. The meta-lens 100 and the meta-mirror 200 form an align key AK. Any one of the substrate structures SS3 and SS4 may be provided with a wiring layer provided with metal wirings for driving and coupling the two devices DE1 and DE2.

FIG. 21 shows that devices DE3 each including a meta-lens 100 and a meta-mirror 200 are bonded to a substrate structure SS7 including the meta-lenses 100 and the meta-mirrors 200. According to an embodiment, the substrate structure SS7 may include devices and wirings.

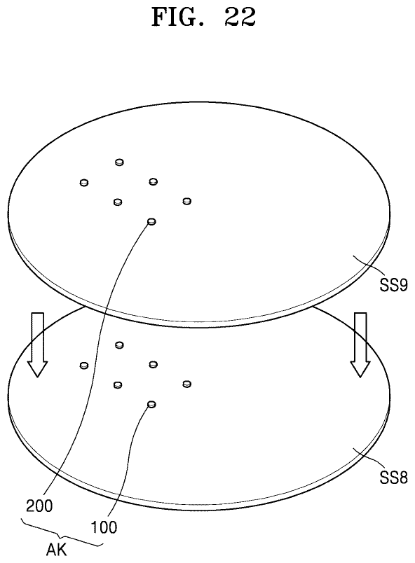

FIG. 22 shows that a substrate structure SS8 provided with meta-lenses 100 and a substrate structure SS9 provided with meta-mirrors 200 are bonded to each other. According to an embodiment, the substrate structures SS8 and SS9 may include devices and wirings.

The align keys AK illustrated in FIGS. 19 to 22 may include any one of the align keys 300 and 301 described above or a structure modified therefrom.

The align key and the apparatus including the same described above have been described with reference to embodiments shown in the drawings.

By using the align keys described above, an alignment error during a stacking process of various electronic and optical devices may be accurately measured.

The aligning apparatus including the align key described above may be more accurately manufactured because the distance between the two structures as well as the horizontal misalignment between the two bonded structures may be measured together.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. An align key comprising:
a meta-lens comprising a first meta-lens and a second meta-lens, each of the first meta-lens and the second meta-lens provided with a plurality of first nanostructures; and
a meta-mirror provided to face the meta-lens while being spaced apart from the meta-lens, the meta-mirror comprising a first meta-mirror and a second meta-mirror, each of the first meta-mirror and the second meta-mirror provided with a plurality of second nanostructures,
wherein, based on a configuration of the plurality of first nanostructures, the first meta-lens and the second meta-lens have focal lengths of opposite signs,
wherein, based on a configuration of the plurality of second nanostructures, the first meta-mirror and the second meta-mirror have focal lengths of opposite signs, wherein an interference pattern is formed based on the first meta-lens and the first meta-mirror configured to transmit and reflect a first light beam of incident light, and the second meta-lens and the second meta-mirror configured to transmit and reflect a second light beam of the incident light.

2. The align key of claim 1, wherein
the first meta-lens has a positive focal length based on the plurality of first nanostructures provided in the first meta-lens,
the second meta-lens has a negative focal length based on the plurality of first nanostructures provided in the second meta-lens,
the first meta-mirror has a negative focal length based on the plurality of second nanostructures provided in the first meta-mirror, and
the second meta-mirror has a positive focal length based on the plurality of second nanostructures provided in the second meta-mirror.

3. The align key of claim 1, wherein
the first meta-lens and the first meta-mirror are configured such that the first light beam is reflected by the first meta-mirror and the first light beam that has been reflected by the first meta-mirror is transmitted through the first meta-lens, and
the second meta-lens and the second meta-mirror are configured such that the second light beam is reflected by the second meta-mirror and the second light beam that has been reflected by the second meta-mirror is transmitted through the second meta-lens.

4. The align key of claim 1, wherein
the first meta-lens and the first meta-mirror are configured such that the first light beam is transmitted through the first meta-lens and the first light beam that has been transmitted through the first meta-lens is reflected by the first meta-mirror, and
the second meta-lens and the second meta-mirror are configured such that the second light beam is transmitted through the second meta-lens and the second light beam that has been transmitted through the second meta-lens is reflected by the second meta-mirror.

5. The align key of claim 1, wherein the plurality of first nanostructures or the plurality of second nanostructures have a cylindrical or polygonal pillar shape.

6. The align key of claim 1, wherein at least one of the plurality of first nanostructures and the plurality of second nanostructures comprises a first-layer nanostructure and a second-layer nanostructure provided on the first-layer nanostructure.

7. The align key of claim 6, wherein the second-layer nanostructure has an asymmetric cross-section in which a major axis and a minor axis are defined, and an arrangement angle of the major axis is arranged differently according to a position of the second-layer nanostructure.

8. The align key of claim 1, wherein, based on a shape distribution of the plurality of first nanostructures, at least one of the first meta-lens and the second meta-lens is further configured to deflect the incident light and emit the deflected incident light.

9. The align key of claim 1, wherein the meta-lens comprises:
the first meta-lens which is an annular region with an outer radius r1 and an inner radius r2; and
the second meta-lens which is an annular region with an outer radius r3 and an inner radius r4,
wherein the meta-mirror comprises:
the first meta-mirror which is an annular region with an outer radius r5 and an inner radius r6; and
the second meta-mirror which is an annular region with an outer radius r7 and an inner radius r8, and
wherein r1>r2>r5>r6>r7>r8>r3>r4.

10. The align key of claim 1, wherein
the first meta-lens comprises a first first meta-lens and a second first meta-lens, the second meta-lens comprises a first second meta-lens and a second second meta-lens, the first first meta-lens, the first second meta-lens, the second second meta-lens, and the second first meta-lens are sequentially spaced apart from each other,
the first meta-mirror comprises a first first meta-mirror and a second first meta-mirror, the second meta-mirror comprises a first second meta-mirror and a second second meta-mirror, the first first meta-mirror, the first second meta-mirror, the second second meta-mirror, and the second first meta-mirror are sequentially spaced apart from each other, and
each of the first first meta-lens, the first second meta-lens, the second second meta-lens, and the second first meta-lens has a rectangular shape.

11. An aligning apparatus comprising:
a light source configured to a first light beam and a second light beam;
a first structure provided with a meta-lens comprising a first meta-lens and a second meta-lens, each of the first meta-lens and the second meta-lens provided with a plurality of first nanostructures;
a second structure provided to face the first structure while being spaced apart from the first structure, the second structure provided with a meta-mirror comprising a first meta-mirror and a second meta-mirror, each of the first meta-mirror and the second meta-mirror provided with a plurality of second nanostructures;
an imaging device configured to measure an interference pattern formed by the first light beam transmitted and reflected by the first meta-lens and the first meta-mirror and the second light beam transmitted and reflected by the second meta-lens and the second meta-mirror;
a processor configured to analyze an alignment state between the first structure and the second structure based on the interference pattern; and
a driving unit configured to move one of the first structure and the second structure according to control by the processor to change a relative positional relationship between the first structure and the second structure,
wherein, based on a configuration of the plurality of first nanostructures, the first meta-lens and the second meta-lens have focal lengths of opposite signs,
wherein, based on a configuration of the plurality of second nanostructures, the first meta-mirror and the second meta-mirror have focal lengths of opposite signs.

12. The aligning apparatus of claim 11, wherein
the first meta-lens has a positive focal length based on the plurality of first nanostructures provided in the first meta-lens,
the second meta-lens has a negative focal length based on the plurality of first nanostructures provided in the second meta-lens,
the first meta-mirror has a negative focal length based on the plurality of second nanostructures provided in the first meta-mirror, and
the second meta-mirror has a positive focal length based on the plurality of second nanostructures provided in the second meta-mirror.

13. The aligning apparatus of claim 11, wherein
the first meta-lens and the first meta-mirror are configured such that the first light beam is reflected by the first meta-mirror and the first light beam that has been reflected by the first meta-mirror is transmitted through the first meta-lens, and
the second meta-lens and the second meta-mirror are configured such that the second light beam is reflected by the second meta-mirror and the second light beam that has been reflected by the second meta-mirror is transmitted through the second meta-lens.

14. The aligning apparatus of claim 11, wherein
the first meta-lens and the first meta-mirror are configured such that the first light beam is transmitted through the first meta-lens and the first light beam that has been transmitted through the first meta-lens is reflected by the first meta-mirror, and
the second meta-lens and the second meta-mirror are configured such that the second light beam is transmitted through the second meta-lens and the second light beam that has been transmitted through the second meta-lens is reflected by the second meta-mirror.

15. The aligning apparatus of claim 11, wherein
at least one of the plurality of first nanostructures and the plurality of second nanostructures comprises a first-layer nanostructure and a second-layer nanostructure provided on the first-layer nanostructure, and
the second-layer nanostructure has an asymmetric cross-section in which a major axis and a minor axis are defined, and an arrangement angle of the major axis is arranged differently according to a relative position of the second-layer nanostructure.

16. The aligning apparatus of claim 11, wherein, based on a shape distribution of the plurality of first nanostructures, at least one of the first meta-lens and the second meta-lens is further configured to deflect incident light and emit the deflected incident light.

17. The aligning apparatus of claim 11, wherein the meta-lens comprises:
the first meta-lens which is an annular region with an outer radius r1 and an inner radius r2; and
the second meta-lens which is an annular region with an outer radius r3 and an inner radius r4,
wherein the meta-mirror comprises:
the first meta-mirror which is an annular region with an outer radius r5 and an inner radius r6; and
the second meta-mirror which is an annular region with an outer radius r7 and an inner radius r8, and
wherein r1>r2>r5>r6>r7>r8>r3>r4.

18. The aligning apparatus of claim 11, wherein
the first meta-lens comprises a first first meta-lens and a second first meta-lens, the second meta-lens comprises a first second meta-lens and a second second meta-lens, the first first meta-lens, the first second meta-lens, the second second meta-lens, and the second first meta-lens are sequentially spaced apart from each other,
the first meta-mirror comprises a first first meta-mirror and a second first meta-mirror, the second meta-mirror comprises a first second meta-mirror and a second second meta-mirror, the first first meta-mirror, the first second meta-mirror, the second second meta-mirror, and the second first meta-mirror are sequentially spaced apart from each other, and
each of the first first meta-lens, the first second meta-lens, the second second meta-lens, and the second first meta-lens has a rectangular shape.

19. The aligning apparatus of claim 11, wherein the processor is configured to analyze at least one of a misalignment state between the first structure and the second structure in a direction perpendicular to an optical axis based on the interference pattern and a distance between the first structure and the second structure in an optical axis direction.

20. The aligning apparatus of claim 11, further comprising an optical path switching member arranged in an optical path between the imaging device and the first structure to change a path of light that has transmitted through the meta-lens to head towards the imaging device.
